(19) United States
(12) Patent Application Publication
(10) Pub. No.: US 2009/0177626 A1
(43) Pub. Date: Jul. 9, 2009

(54) APPARATUS AND METHOD FOR INVESTIGATIVE ANALYSIS OF LAW ENFORCEMENT CASES

(76) Inventor: Robert Lottero, Jefferson, NH (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 12/127,007

(22) Filed: May 26, 2008

Related U.S. Application Data
(60) Provisional application No. 61/019,240, filed on Jan. 5, 2008.

(51) Int. Cl. G06F 7/00; G06F 17/30

(52) U.S. Cl. 707/3; 707/E17.142

(57) ABSTRACT

A method for determining links between target A and target B. The method comprises: identifying attributes of target A, identifying attributes of target B, determining direct links or common attributes among the identified attributes of target A and the identified attributes of target B, identifying open links from the step of determining direct links or common attributes, wherein the open links comprise identified attributes of target A that are not directly linked to target B, using the open links, determining remote links between target A and target B and displaying the direct links and the remote links.

### REFERENCE TO RELATED APPLICATIONS

This application claims the benefit, under 35 U.S.C. 119(e), of the provisional patent application entitled Apparatus and Method for Investigative Analysis of Law Enforcement Cases filed on Jan. 5, 2008 and assigned application number 61/019,240.

### BACKGROUND OF THE INVENTION

During the course of a criminal investigation, the law enforcement community is inundated with data. There are numerous potential leads that can be followed and each lead potentially creates many more leads to be followed. Investigators are quickly overwhelmed with the amount of information they must analyze and manage. Additionally, there is the problem of identifying those leads that are most likely to uncover important evidence or data for use during prosecution of the wrongdoers. The investigative analysis apparatus and method of the present invention assist the investigator with the management of a case throughout its life cycle and identify leads that are most likely to bear fruit. It also organizes all data collected during the case and presents the data in a way that assists prosecution of criminals.

### BRIEF DESCRIPTION OF THE DRAWINGS

Embodiments of the invention are explained in the following description in view of the drawings that show:

FIGS. 1-3 illustrate the target links determined according to the teachings of the present invention.

FIG. 4 illustrates an inner circle of a target subscription.

FIG. 5 illustrates a timeline chart showing starting and ending dates for associations within the inner circle of a target subscription.

### DETAILED DESCRIPTION OF THE INVENTION

Before describing in detail the particular method and apparatus related to an investigative analysis of law enforcement cases, it should be observed that the present invention resides primarily in a novel and non-obvious combination of elements and process steps. So as not to obscure the disclosure with details that will be readily apparent to those skilled in the art, certain conventional elements and steps have been presented with lesser detail, while the drawings and the specification describe in greater detail other elements and steps pertinent to understanding the invention.

The following embodiments are not intended to define limits as to the structure or method of the invention but only to provide exemplary constructions. The embodiments are permissive rather than mandatory and illustrative rather than exhaustive.

The apparatus and method of the present invention comprises a plurality of independent elements and features. Although described in conjunction with a single embodiment of the invention, those skilled in the art recognize that one or more of the elements and features can be combined in different embodiments and can be separately employed.

The following definitions are provided to help clarify these terms as used to explain the present invention:
Entity: a person, enterprise, location, or object.
Target: the entity upon which the analysis is focused; the “seed” or starting place of the analysis.
Communication Subscription: any type of communication subscription assigned to a person, such as a phone number or email address.

### Two-Entity Linkage Analysis

Background: An important component of an investigation involves the interrelation and interaction of people, places and objects and the identification all possible relationships involving these entities. For instance, information about any two entities, such as person A and person B, may be collected by more than one investigator during the course of an investigation. However it is possible that no single investigator will know if and how these two people are related. Assembling all the information/observations that tie two people together may be critical to the investigation.

Functionality: The two-entity linkage analysis of the present invention allows the user to specify any two entities (person, enterprise, location, object, etc.). The algorithm examines all direct and implied links via some common attribute or action of the two entities by scanning for any possible common entity matches or connecting links. An example of a link is two crime suspects having some association with the same building. The algorithm searches any number of user-specified levels and identifies all link paths that may result in a connection between the targeted entities. For example, a level two linkage between A and B is one in which A is linked to C and C is linked to B. In another example, a level three linkage between A and B is one in which A is linked to C, C is linked to D, and D is linked to B. The algorithm will find all links with levels up to and including the highest level of linkage specified by the user.

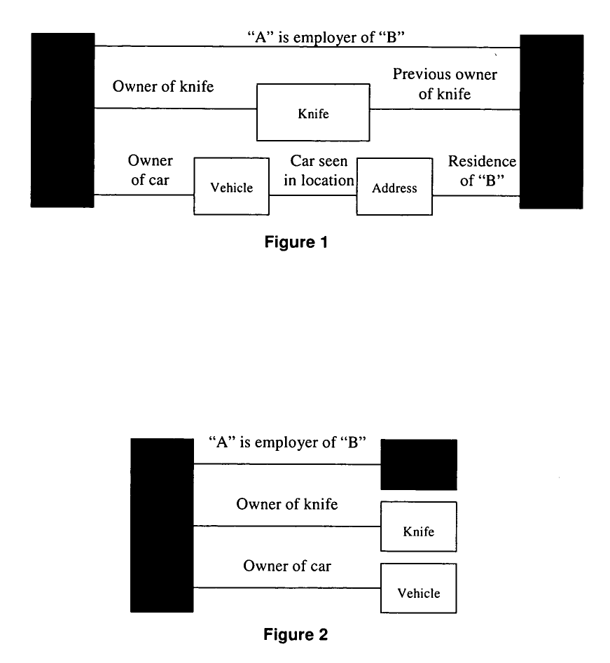

FIG. 1 illustrates how person A and person B can be linked together through multiple levels of linkages (1-level, 2-level and 3-level linkages illustrated). As illustrated, A is an employer of B (1-level linkage). Further, B was the previous owner of a knife currently owned by A (2-level linkage). Also, A owns a car that was seen in a specified location; the specified location is determined to be a residence of B (3-level linkage).

The linkage analysis algorithm comprises the following process steps.

1. Run a level one (1-level) linkage analysis on Target A searching for ties (direct links) to Target B, including any types of links desired (common possessions, common locations, etc.). This is illustrated in FIG. 2.

2. Determine whether one of the hits in the 1-level linkage analysis (a cross reference) is Target B and complete/close a record for that chain if the determination is affirmative. A level one linkage analysis is complete at this point. If the level one analysis does not identify links (common attributes) from Target A to Target B or if the investigator desires to continue the analysis to identify intermediate links (i.e., links beyond the 1-level linkages) between Targets A and B, continue with the step 3.

3. Run the next level linkage analysis (2-level linkage from Target A) on the entities found on all open chains (open links) in the step 2. This is illustrated in FIG. 3.

4. Determine whether any of the hits found in step 3 link to Target B. Loop back to the step 3 for a user-specified number of iterations through the loop, with each iteration searching for increasingly remote links between Targets A and B.

5. Run a linkage analysis for Target B searching for ties to Target A, including executing the steps 2-4 above.

The present system and method provides the search capability to identify links that are more remote or deeper than a direct link between Targets A and B. The linkage depth is user-determined according to a user-specified link level. The system and method of the invention stores all data (relationships, actions, observations, etc.) that is necessary to conduct the linking analysis and presents the findings to the user in the form of a linkage graph or in textual form.

The above-described invention includes generalization to linkage analysis between any number of entities. It is not limited to linkages between only two entities.

### Inner Circle Identification

Background: At any time a target can be associated with many individuals. However, many of those individuals are not involved in the criminal activity under investigation. Common thinking among law enforcement intelligence community is that the people who get the most communications (telephone call, for example) from a target are the “inner circle” of a given target and involved in the criminal activity. While those telephone call recipients may be candidates for the target's “inner circle”, the fact that they receive frequent communications is not necessarily sufficient to assign the recipients to the “inner circle.”

Consider a person involved with three other individuals in an organized crime conspiracy. He has a girlfriend who is not involved in the criminal activity and is not aware of its existence. Even though his uninvolved girlfriend receives more communications from him than any of the co-conspirators, she should not be considered a part of his criminal operations “inner circle.” The foregoing scenario is common, and when simple call frequency and similar analyses are employed to define criminal interrelationships, an investigator can be fooled with unfruitful leads.

Functionality: Rather than using simply the call frequency between a target and each of his associates, the present invention considers implied links among the players based on the timing and the sequence of communications between the target and others. For purposes of this invention, any type of communication can be considered, such as telephone calls (landline and mobile), emails and text messages. When these implied links are integrated with the obvious direct links between the target and each of the people with whom he/she communicated, a truer picture of the interrelations is constructed. This approach not only defines the possible/probable grouping of individuals into members of the inner circle and outsiders, but may also infer hierarchical associative status among the groups so defined (i.e., “customers” or “suppliers” to the inner circle). The algorithm includes these basic steps:

1) Select a “target communications subscription”. This is a communication subscription on which the analysis will be run.

2) For all communication subscriptions involved in communications with the target subscription, calculate the total number of communications involving the communication subscription, and the number of “Patterns” involving each communication subscription. A “Pattern” is defined as a repeated sequence of communications made between a fixed set of communication subscriptions within a defined maximum elapsed time between communications (an example of a sequence would be where A calls B, then within X minutes of elapsed time B calls C, then within X minutes of elapsed time C calls D). The sequential orders in which the communication subscriptions are involved in the sequence are inconsequential. For example, the following sequences would be considered instances of the same sequence because they all involve A, B, C, and D:

A calls B, then B calls C, then C calls D

C calls A, then A calls D, then D calls B

A calls D, then D calls C, then C calls B

3) Identify the “trial core workgroup”. This group of communication subscriptions is the list of communication subscriptions with a high value obtained from either a) the total number of communications with any other communication subscriptions in the trial workgroup or b) the total number of communications with any other communication subscriptions in the trial workgroup multiplied by the number of patterns involving the said communication subscription. As is known by those skilled in the art of investigations, various measures and thresholds can be used to determine what a “high” value is.”

4) Check all “Patterns” that include a communication subscription from the “trial core workgroup”. For each Pattern, make a list of all other communication subscriptions in the Pattern that are in the “trial core workgroup”.

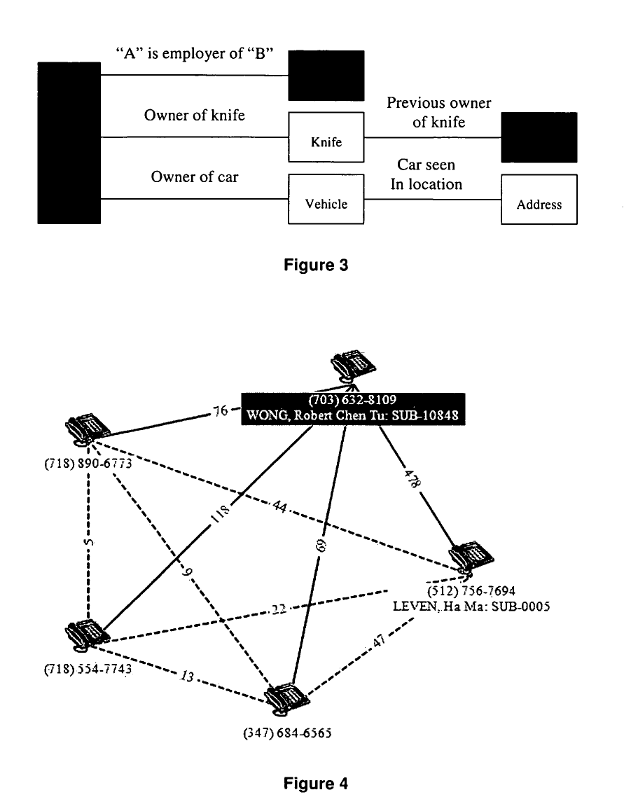

5) The suspected Core Workgroup members will be the “trial core workgroup subscriptions” with a high number created by multiplying the total number of communications by the number of instances of being involved in Patterns that include other communication subscriptions in the “trial core workgroup”. This is the “Inner Circle” of the person with the target subscription. FIG. 4 illustrates an Inner Circle. The target communication subscription is highlighted. The solid lines connecting the target communication subscription to the other communication subscriptions represent communications made between the respective communication subscriptions. The numbers shown in the mid-points of the lines show how many communications were made between the two communication subscriptions. The dashed lines represent the implied linkages between the remaining communication subscriptions, based on the number of times that communications made between the target communication subscription and the first of the other communication subscriptions and communications made between the target number and the second of the other communication subscription were in the same “Pattern” as defined above. In this example, telephone number (703) 632-8109 was involved in a call with telephone number (718) 890-6773 76 times. Telephone number (703) 632-8109 was involved in a call with telephone number (312) 756-7694 478 times. The “other two communication subscriptions” ((718) 890-6773 and (312) 756-7694) were involved together in Patterns with telephone number (703) 632-8109 44 times. There is therefore an implied linkage between the “other two communication subscriptions” because there is a pattern of repeated sequences involving all three communication subscriptions.

6) A metric for each communication subscription in the trial core workgroup is obtained by multiplying the total number of communications by the number of instances of involvement in Patterns with other communication subscriptions in the “trial core workgroup”. The communication subscriptions with the lowest metrics are the suspected Customers or Suppliers to the Inner Circle. The reasoning behind this is that customers and suppliers are not usually involved in day-to-day communications as heavily as the core group.”

### Determination of Churn in Inner Circle

Background: Over time, a core group of people associated with a target person can change. It is useful for an investigator to know when these changes occur.

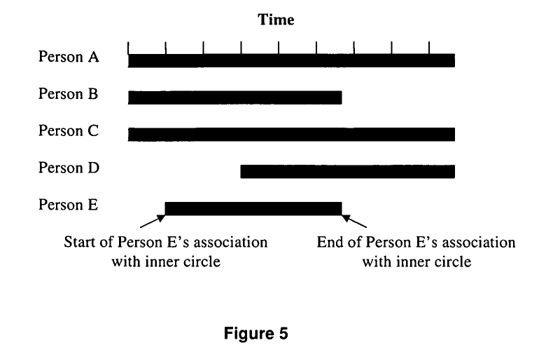

Functionality/Uniqueness: This is an extension of the previously-described invention to identify the Inner Circle of a target person. The Inner Circle of people associated with a target person is analyzed over time. Associations with Inner Circle(s) can be depicted on a timeline chart, with the starting and ending dates for associations with each Inner Circle indicated, as illustrated in FIG. 5.

### Stopped Contact Analysis

Background: Sometimes a pattern of communications between people is established. The communications pattern may stop for any of several different reasons. For example, the telephone number of one person in the pattern may have changed. This is useful information for an investigator.

Functionality: A stopped contact analysis process notes the communication patterns (email, mail, telephone, etc.) between a target person and another person and notes if the pattern stops. If the pattern stops at some point, the system looks for a similar pattern that starts at a later time. If a similar pattern is found, the old and new patterns are presented to the user as possibly related patterns.

### Identifying Target Associate Candidates for “Rolling” or Serving as a Source/informant

Background: Criminal groups are not unlike business and social associations in that they are subject to the same emotional involvements and powerful psychological relationships such as love, hate and jealousy. The present invention attempts to identify any associate or acquaintance of the target who may have fallen into disfavor with certain members of the criminal organization or otherwise appears to have a negative relationship with one or more members of the organization. Such an individual, when presented with the opportunity to cooperate with law enforcement in exchange for some favorable prosecutorial consideration is more likely than others to accept such an arrangement. Many cases are resolved using this approach, but the case investigators must decide who is approachable based on their knowledge of the parties involved and of the subject targeted for such a proffer. The number of procedural operations necessary to achieve the above-described functionality can be physically prohibitive for manual implementation, and thus there is the need for an automated solution.

Functionality: Obviously, personal factual knowledge and experiences of the case investigator will always take precedence in identifying individuals to be proffered. The present invention employs a heretofore unknown criterion to be considered when selecting individuals to be proffered. The invention searches for time periods during which one or more members of a group stop having known contact with other members of the group. Such contacts can include emails, phone calls, and shipments. The invention assigns a numerical score to people in the group based on their level of involvement in the group and the amount of time they were actively in contacts with the group before the contacts ended or significantly declined. The scores are ranked to determine individuals who may be candidates for rolling.

An additional step can be taken to strengthen the evidence that a person is a candidate for being an informant. The date that a group member stops having contact with other members of the group is significant. If the group begins a pattern of contacts with another person at about the same time that communication with the first person ended, then this might indicate that the first person was replaced by the group with the second person. If this is indeed what happened, then there is added reason to believe that the person who stopped having contacts with the group might have fallen out of favor with the group.

### Determination of Who Is the Leader of a Group

Background: Most groups of people operate with a person in charge of the group. This person in charge can be considered the leader, or “boss” of the group. Often people in the lower tiers of the group will communicate among themselves to develop a message worth relaying to the leader of the group. When this happens, a chain of communications often stops once the leader receives the information. The patterns of communications among people in a group can be used to determine the likelihood that a particular person is the leader of the group.

Functionality: A group of people is analyzed to determine who is most likely to be the leader of the group. For each communication subscription (e.g., phone number, email address, etc.) assigned to each person in the group, all incoming communications to each subscription from another subscription in the group are identified. For any given subscription, the percentage of times that the subscription makes an outgoing communication within a specified time limit after it receives a communication from someone in the group is calculated. Once the percentages are calculated for each subscription in the group, the subscriptions are ranked by ascending percentage. The subscription with the lowest percentage is the most likely to be correctly assessed to be the “leader” of the group.

Subscriptions with an insufficient number of call records to make a confident ranking of probability of being assigned to the leader are disqualified from being in the list of candidates. The minimum number of call records needed for a confident ranking is subjective, but one measure is to require that the subscription be involved in at least a particular percentage of all of the communications involving the entire group.

### Causal/Operational/Reactive Analysis

Background: It could be argued that events don't just “happen” somehow and somewhere, isolated from all other events in space and time. A study of any event will usually uncover related actions that can be classified into three distinct categories—(1) Actions that caused the subject event to occur or at least established the preconditions leading to the event; (2) Actions that were affected during the event and that facilitated and/or supported its progress and continuation, and (3) Actions that occurred after the event as a reaction to its occurrence. In the present embodiment, these three categories are referred to a causal, operational and reactive, respectively. There may be a fine line (usually a temporal line) separating these categories and thus assignment of an event to a category, and thus the definitions of the categories may be somewhat subjective. But regardless of where the lines separating the categories are drawn, the concept is valid. For example, when investigating the 9/11 Twin Towers bombing, there were distinct causal actions that occurred—the placing of the terrorists within the US, the training of pilots, etc. It could be argued that the operational actions began when the terrorists boarded the planes.

Functionality: According to the present invention, this analysis begins by examining the chronology of telephone calls, door actuations, and other recorded activities at about the same time as user-specified events (typically security breaches). The analysis continues by finding those individuals who repeatedly call the same people or actuate (walk through the same door(s) at about the same time relative to the occurrence of an event. For instance, if a person makes a call to 312-234-1234 approximately one hour before a recorded event (security breach, or shipment, or criminal act, etc.) and this occurs several times before several similar events, the analysis process identifies the person's actions as having a high “causal index”. A high causal index implies that the phone call may have caused the event to occur or contributed to its occurrence.

Similarly, this analysis identifies reactions to events that happen. For instance, if a person makes a call to 312-234-1234 within five minutes after a security breach (or shipment, or criminal act, etc.) and if that same person performs the same action after several different recorded events, the analysis process identifies that person's actions as having a high “reactive index”. A high reactive index implies that the phone call may have been made in reaction to the occurrence of the event.

### Event Pattern Analysis

Background: It is sometimes useful during an investigation to spot repeated patterns of behavior.

Functionality: An event pattern analysis searches for repeats of event patterns. For example, after a telephone call between two particular people, two people (the same people on the call or different people) meet in a particular place within a specified period of time from the call. This same series of events occurs repeatedly. The number of times each event pattern occurs is noted, allowing the investigator to investigate more fully those event patterns that are of interest. This analysis is different from the “Causal/Operational/Reactive Analysis” embodiment previously described in that the former embodiment identifies events that occur in relation to a particular incident(s); this present embodiment identifies two or more events that occur in relation to each other.

An “event type” is defined as the uniquely-identifying characteristics of an event, such as entities involved and a summary of the action. To facilitate analysis using a computer database, each “event type” is assigned a unique code for the purpose of standardizing the way that the event type is stored in the database. Each event is assigned an event type code along with its date and time that the event occurred, so that each instance of an event can be uniquely identified. After events have been stored in a database with unique combinations of event types and date/time stamps, then the computer can search for repeats of event patterns, where a “pattern” is defined as a repeated sequence of events, where each sequence of events happens within a defined amount of time.

For example, a sequence might be that a company employee enters a corporate building through a particular door, and within two minutes a fire alarm is triggered in the same building. The first event (“Event 1”) is the employee entering the corporate building. Event 1 would be assigned a unique code based on the person involved, the corporate building, and the action of entering the building. The second event (“Event 2”) is the alarm being triggered in the building. Event 2 would be assigned a unique code based on the building identification and the action of the alarm being triggered. The sequence would be Event 1 occurring and then Event 2 occurring within a designated time limit (e.g., 5 minutes). If this sequence happens repeatedly (e.g., the sequence happened on May 5^{th} and again on June 12^{th}), then an event “pattern” is created.

The Event Pattern Analysis, then, would uncover the fact that there is a pattern of sequences of events and provide a possible investigative lead to a criminal investigator.

### Automatic Collection of Prosecution Materials for Discovery

Background: Discovery is part of the pre-trial litigation process during which each party requests relevant information and documents from the other side in an attempt to “discover” pertinent facts. The relevant information and documents can include requests for production of documents, and depositions of witnesses. The process of collecting the documentation and witness lists can be very time-consuming for complex cases. A technique for accelerating the process is needed.

Functionality: For each record of information (such as in a database), the source reference information is stored and tied to the record. Each reference information file indicates whether the information is obtained from a witness or a source document, and whether or not the information will be used as evidence in the case. If the information is obtained from a source document, the source document is stored with the reference file, or a hyper link to the source document is included.

The apparatus and method of the present invention provides the framework needed to make the collection of prosecution materials as easy as a push of a button. When the list of witnesses and the documents need to be collected for discovery, the user selects the criminal case and automatically receives a listing of all of the source documents and witnesses to be used in the case and a record of all the said source documents. The listing is used as a table of contents for the source documents, and the table of contents is a set of hyper links to the source documents. By this method a full package of discovery documentation is stored in a location selected by the user. The collection of files can then be copied onto physical media or transmitted electronically to the other party.

While the present invention has been described with reference to preferred embodiments, it will be understood by those skilled in the art that various changes may be made and equivalent elements may be substituted for the elements thereof without departing from the scope of the invention. The scope of the present invention further includes any combination of elements from the various described embodiments. In addition, modifications may be made to adapt a particular situation to the teachings of the present invention without departing from its essential scope. Therefore, it is intended that the invention not be limited to the particular embodiments disclosed, but that the invention will include all embodiments falling within the scope of the appended claims.

1. A method for determining links between target A and target B, comprising:
identifying attributes of target A;
identifying attributes of target B;
determining direct links or common attributes among the identified attributes of target A and the identified attributes of target B;
identifying open links from the step of determining direct links or common attributes, wherein the open links comprise identified attributes of target A that are not directly linked to target B;
using the open links, determining remote links between target A and target B; and
displaying the direct links and the remote links.

2. The method of claim 1 wherein the attributes of target A comprise current and former residence addresses, current and former schools attended, current and former work addresses, current and former vocations, current and former contact information, current and former member of a sports team, acquaintances, locations visited within user-determined time period, current and former possessions alibi information shipment information financial accounts business agreements, activities and identification information, and wherein the attributes of target B comprise current and former residence addresses current and former schools attended current and former work addresses current and former vocations current and former contact information current and former member of a sports team, acquaintances locations visited within a user-determined time period, current and former possessions alibi information shipment information financial accounts business agreements, activities and identification information.

3. The method of claim 1 wherein the remote links comprise a chain of one or more intermediate attributes that link an identified attribute of target A with an identified attribute of target B.

4. The method of claim 1 wherein a depth of the remote links is user selectable.

5. The method of claim 1 wherein the step of using the open links to determine remote links between target A and target B further comprises:
(a) searching a data base of target A attributes;
(b) determining one or more links from the target A attributes;
(c) determining whether the one or more links link indirectly to target B; and
(d) iterating through the steps (b) and (c) a user-selected number of times to determine the remote links between target A and target B.

6. The method of claim 1 wherein the step of displaying comprises displaying the direct links and the remote links in a linkage graph or in textual form.

7. A method for determining a core workgoup or an inner circle of associates of a target, the method comprising:
(a) selecting a target communication subscription of the target;
(b) for each candidate communication subscription& involved in communications with the target communication subscription, determining a total number of communications involving the target communication subscription;
(c) for each candidate communication subscription, determining a number of communication patterns involving the target communication subscription;
(d) determining a value of each communication pattern; and
(e) identifying a trial core workgroup responsive to steps (c) and (d).

8. The method of claim 7 wherein each pattern comprises a sequence of communications between members of a group and each pattern further comprises the target communication subscription and one or more of the candidate communication subscriptions, and wherein each communication in the sequence of communications occurs within a predetermined amount of time after an immediately previous communication.

9. The method of claim 7 for determining customers or suppliers of the core workgroup by determining a second number by combining a total number of communications of a trial core workgroup member with a number of instances of involvement in a pattern with other members of the trial core workgroup, wherein the second number is less than the first number.

10. The method of claim 7 further comprising determining changes in members of the trial core workgroup and displaying members of the trial core workgroup at different times.

11. A method for determining changes in patterns of contact between a first and a second individual, the method comprising:
identifying a first pattern of communications between the first and the second individuals; and
determining whether a second pattern of communications between the first and the second individuals begins after a termination of the first pattern.

12. The method of claim 11 further comprising assigning a score to the first individual, the second individual and to each other member of the group based on the number of contacts with other members of the group during the first and the second time periods.

13. The method of claim 12 wherein the score is further responsive to a level of involvement of each member in the group.

14. The method of claim 12 wherein the score is further responsive to a date when a member of the group stops contact with other members of the group.

15. A method for determining a leader of a group, the method comprising:
determining all incoming communications for each communication subscription for each member of the group;
determining outgoing communications for all communications subscriptions from each member of the group within a predetermined time from receiving a communication; and
determining the group leader responsive to the outgoing communications.

16. A method for determining actions related to the occurrence of a first event, the method comprising:
(a) determining a chronology of actions in relation to a user-specified first event;
(b) determining actions having a temporal relationship to the occurrence of the first event;
(c) determining a time interval between each one of the actions determined at step (b) and the first event; and
(d) determining a relationship between the action and the first event.

17. The method of claim 16 wherein the relationship comprises a causal action, an operational action or a reactive action.

18. The method of claim 16 wherein the action comprises a second event, the method further comprising determining repeated occurrences of the first event followed or preceded by the second event and a number of times the first event is followed or preceded by the second event.

19. The method of claim 18 wherein each of the first and the second events is assigned an event type, a date of occurrence and a time period between the first event and the second event.

20. The method of claim 7 for determining a core workgroup of the target, the method further comprising:
(f) identifying all communication patterns that include a communication subscription of a member of the trial core workgroup;
(g) identifying trial core workgroup members in each pattern identified at the step (f);
(h) determining a core workgroup responsive to membership in the trial workgroup and responsive to a first number created by combining the total number of communications of a trial core workgroup member with a number of instances of involvement in a pattern with other members of the trial core workgroup.

21. A method for determining changes in contacts between members of a group, the method comprising:
determining contacts between one or more members of the group during a first time period;
determining contacts between one or more members of the group during a second time period, the contacts during the second time period fewer than the contacts during the first time period; and
assigning a score to each member of the group based on the number of contacts with the other members of the group during the first time period and the second time period.

22. The method of claim 16 wherein the first event can be selected for analysis or can be selected from a plurality of events.
